(19) United States
(12) Patent Application Publication
(10) Pub. No.: US 2015/0319200 A1
(43) Pub. Date: Nov. 5, 2015

(54) Natural User Interface for Remote Communication: An Interactive Collaboration System that allows Co-drawing Pad, Co-browsing/sharing Web/Document Files Using Session Initial Protocol (SIP)/Short Message Peer-to-Peer Protocol (SMPP) to Wake Up Remote Devices

(71) Applicants: William H. Nguyen, Sunnyvale, CA (US); Son T. Tran, Hochiminh (VN)

(72) Inventors: William H. Nguyen, Sunnyvale, CA (US); Son T. Tran, Hochiminh (VN)

(73) Assignee: VOXYPAD INC., Sunnyvale, CA (US)

(21) Appl. No.: 14/701,851

(22) Filed: May 1, 2015

Related U.S. Application Data
(60) Provisional application No. 61/988,121, filed on May 2, 2014.

(51) Int. Cl. H04L 29/06; H04L 29/08

(52) U.S. Cl. CPC H04L 65/403; H04L 67/104; H04L 67/1095; H04L 67/02; H04L 65/1006; H04L 67/42

(57) ABSTRACT

This patent describes a system where we can share some information such as photos, images, electrical documents, and web screen through the TCP/IP or Peer-to-Peer protocol network. From this system, one user can activate a drawing board application and connect his/her computer with the other users through the friend list. One client's application can activate another's application in remote devices by using the session initial protocol (SIP) or short message peer to peer protocol (SMPP). By using SMPP or SIP, one user can trigger the application of another user in a remote device to set up an interactive collaboration. After the connection has been set up, the user can draw and share drawing results with other connected computers. One client can also open a browser inside the working pad and input URL to browse the web's contents. At the same time, the web browser of other connected client's devices will be automatically opened and synchronized the web's content. Similarly, the user can open and share a PDF, or WORD, or POWERPOINT file uploaded from the local disk or cloud-based storage to the working pad of user application.

### CROSS REFERENCE TO RELATED APPLICATIONS

This application claims the benefit of U.S. Provisional Application No. 61/988,121 entitled “Natural User Interface for Remote Communication: An Interactive Collaboration System that allows Co-drawing Pad, Co-browsing/sharing Web/Document Files Using Session Initial Protocol (SIP)/Short Message Peer-to-Peer Protocol (SMPP) to Wake Up Remote Devices”, filed on May 2, 2014, and the contents of which are incorporated herein by reference in their entirety.

### BACKGROUND OF THE INVENTION

Sharing and visualizing data always play an important role in an interactive system or collaboration-support system. From a great distance, it is not easy to explain one's idea on the phone only. With a video conference system, some printed documents or images may be transferred from one terminal device to another, but this communication is not as natural and convenient as would it be if the two are at the same location and use the blackboard to discuss their ideas.

Much of the work of an interactive or collaborative nature requires screen sharing, which is implemented by sharing web pages between two computers. An example of this application can be found at Joinme.com, where one user can share his/her computer screen through a web browser. Another well-known collaborative environment which is web-based is the “Web Ex” system. The main interaction of Web Ex relies upon streaming and recording online video through a system of plug-in cameras.

Screen sharing is implemented by a remote-access tool such as TeamViewer. This application helps one user to access and control a remote computer from his/her computer through TCP/IP network. The U.S. Pat. No. 8,346,868 B2 of real-time web sharing system is a system where it can share web screens between multiple computers. This model is based on the client/server mode, where the server is used to cache and share the web to multiple clients' screen. Besides screen sharing, sharing messages and images is also one approach of collaborative system and social network. The US patent No. 20130298023 of “Interactive web collaboration systems and methods” is also a system where we can share data and idea through the messages of a chat room.

The common characteristic of all the above sharing-screen applications is a one-way control process, in which interactive collaboration between two or more users is not supported. Without loss of generality, we explain our proposed system of two users. For multiple users and servers, our proposed system will have similar functions and features. In the proposal of this provisional application, two users on two computers connected on the internet can draw graphical lines, type text, open a web browser, take a picture, open images or documents from their computer and put all those data on the working pad's screen. At the same time, data/documents in this drawing pad is shared to other user's drawing pad directly and interactively. The interaction means that two users will have the same contents on their devices' screens and both of them have an equal right to change those contents by drawing graphical lines, typing text, surfing web, taking/uploading pictures or documents. Any change done by one user can be seen on the device's screen of the other immediately. There is no distinction between client and host's application between two users in our proposed system. By co-sharing the web browser and co-sharing contents on the drawing pad, the users can show and share all the data from the internet, document files from their computer/cloud on the working pad and modify it to explain or demonstrate their ideas or concepts.

The session initiation protocol (SIP) is well known for setting up and terminating one VOIP session. Meanwhile, the short message peer to peer protocol (SMPP) is popular for sending and receiving message of short message service (SMS) in telecommunication. Here we utilize SIP and SMPP in our system to sustain users' connection for interactive collaboration. Due to a low capacity of socket-based connection, SIP and SMPP will help to save battery in devices, but it is ready to set up the connection between two remote computers/portable devices immediately on demand.

### BRIEF SUMMARY OF THE INVENTION

The invention includes the client-server processes of sharing between the working pad and the emulated application running on multiple computers or portable devices. There are two parts in the descriptions of this system: 1) Client application and 2) Server application.

In the client application, there are two modes: offline mode and online mode. The online mode means that one client application has a connection to the other client application through sockets and ports. Meanwhile, the offline mode describes the situation when the client application is not connected to other client applications. It means that the servers just need to open and sustain a low capacity socket like that of SIP/SMPP to handle and control client's connection in offline mode. We can see that the online mode describes the situation when the client application has been already connected to the server via a high-capacity socket and it is ready to transfer data and collaborate with the other client's applications. Here we can utilize SIP/SMPP to switch the connection of one client application to the server from offline to online mode and vice versa. The server system will help to transfer the requests for contact, also by using SIP/SMPP, to the other client at the destination and the message sent through SIP/SMPP will wake up the remote client's application to join in meeting with the original client. After finishing collaboration time, those clients' applications will be disconnected to each other. The client application will change into offline mode to sustain the connection to servers through low capacity sockets.

Client applications can operate in real time when one user inputs text, draws free line, opens and surf web, opens document files and show them on his/her working pad; and the other users can immediately see those changes on their working pad. On the other hand, a small change occurring on the working pad of one client application will be seen by the other user at the same time in remote devices. It means that the working pad and all the applications emulated in the window of working pad such as web browser, document reader/editor, game, and presentation applications will play in an interactive environment for online users. This enables the users to play, work, and share idea/knowledge/entertainment interactively and collaboratively. This proposed system is capable of real-time responses during interactive collaboration.

Concurrently, the server application will receive, restore, send, and resend data in both text and graphic formats. There are two kinds of servers in the proposed system. The first server is the MESSAGE server, used to handle login processes and status messages to all users. The second is the DATA server, used to handle data sharing between users during a meeting, such as sharing photos, web links, text and image, etc. Traffic between MESSAGE and DATA servers is secured by encryption. We can see that the server system plays the role as the transmitter and synchronizer between client devices.

Here the proposed system is different from the published patents of collaborative system or screen-sharing system. We combine and utilize texts, images, web data, and documents in an interactive system. We customize the system based on transferring texts, documents, and images by using the client/server model. The data will be sent from one user to the server and the server will transfer the data to other users. The connection of all the terminal devices with the server is set up by using the low-capacity sockets of SIP/SMPP. The applications running on client devices will transfer I images/texts/binary data through MESSAGE and DATA servers when one user needs to share his/her data with other users. Note that all kinds of data can be shared and transferred by using the original files or the image of its appearance in the window of drawing pad. In case of sharing the original files, the application correspondent to reading those files will be activated and emulated into the window of drawing pads running in the client devices of all users attending the meeting.

The main functions of one client application are login, pen, text, photo, web browser, map location, document, redo, undo, eraser, clear, and close.

### BRIEF DESCRIPTION OF DRAWINGS

FIG. 1 (MAIN_SCREEN) shows the main screen of the working pad.

FIG. 2 (MESSAGE_SCREEN) shows the main screen of message where users can send offline and online message. The content of message can be text, URL link, picture, and link of document files.

FIG. 3 (SIP-SMPP_CONTACT) shows the initial contact between two or multiple clients through SIP (Session Initial Protocol) or SMPP (Short Message Peer to Peer) protocol.

FIG. 4 (LOGIN) shows a block diagram of the login process when one user starts to open the application.

FIG. 5 (PEN) shows a block diagram of the pen function.

FIG. 6 (TEXT) shows a block diagram of the text function.

FIG. 7 (WEB) shows a block diagram of the web-browser function.

FIG. 8 (PICTURE) shows a block diagram of the photo function.

FIG. 9 (DOCUMENT) shows a block diagram of the document function. This function helps to import data file into the window of drawing pad and share it to other users.

FIG. 10 (CLOSE) shows a block diagram of the close function.

### DETAILED DESCRIPTION OF THE INVENTION

The following descriptions are explanations of the figures in detail. The system includes two main servers: one is the MESSAGE server and the other is the DATA server. The MESSAGE server is used to transfer messages between the clients for handling and synchronizing information produced by the end users. The DATA server is utilized to transfer data files such as images.

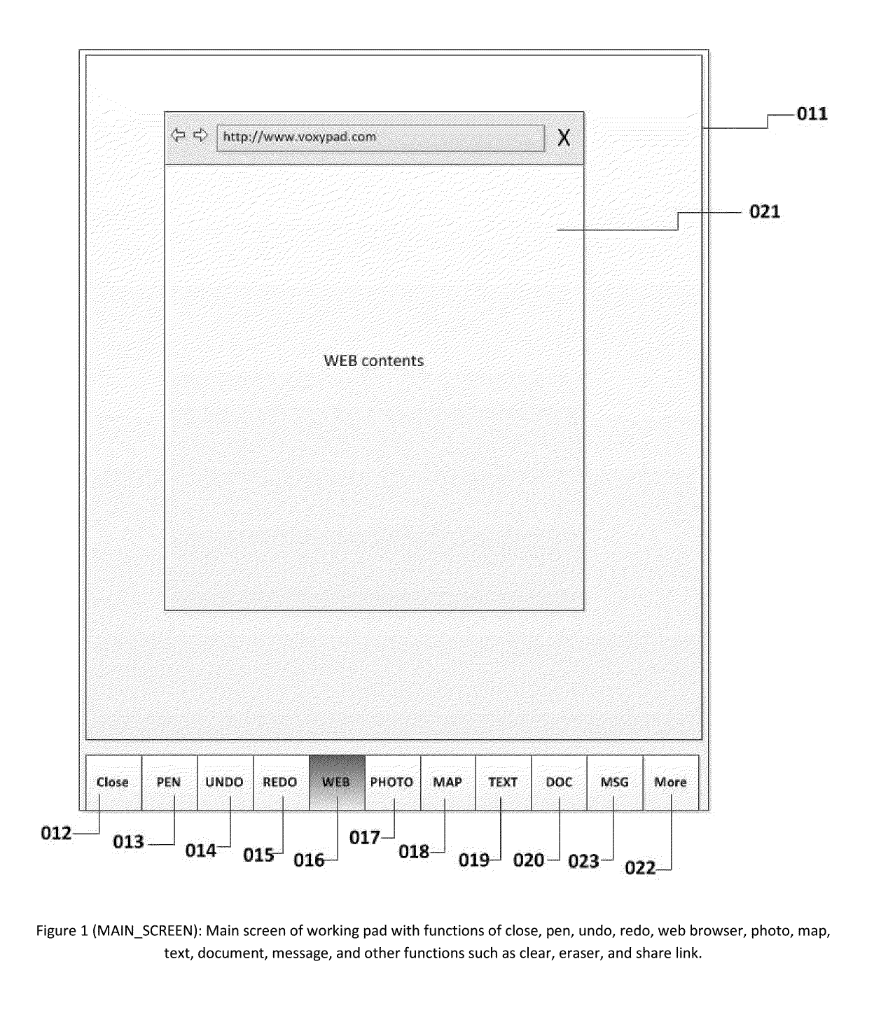

FIG. 1 (MAIN_SCREEN) gives an overview of the main screen of the application. 011 is the whiteboard of working pad. There are functional buttons of close 012, pen 013, text 019, photo 017, web browser 016, map 018, redo 015, undo 014, document 020, message 023, and other functions at 022. When the web button is touched, the window 021 of the web browser will be opened and positioned inside the drawing pad 011. The client software application includes the modules for login, pen, text, photo, web browser, document, message, redo, undo, eraser, clear, close, and location map.
Two functions undo 014 and redo 015 are influenced to photo and pen functions. These two processes are based on n images of the previous steps which are recorded in the memory of the local devices. After the working pad is changed on a local device, the message of action to make that change and the image of the working pad are broadcasted to all other users at the meeting through MESSAGE and DATA server systems.
Eraser function is similar to pen function 013, but the color of pen is the background color.
Location map 018 is a Web application combined with GPS system in the client devices/terminal.
Clear function is activated by touching the clear function in more 020. This function will clean the content of the working pad and reset it to the initial condition. The user application will broadcast the clear function to the other users at the meeting through the MESSAGE server. The other terminals will call clear function to carry out the task immediately when it receives the CLEAR message from the server.

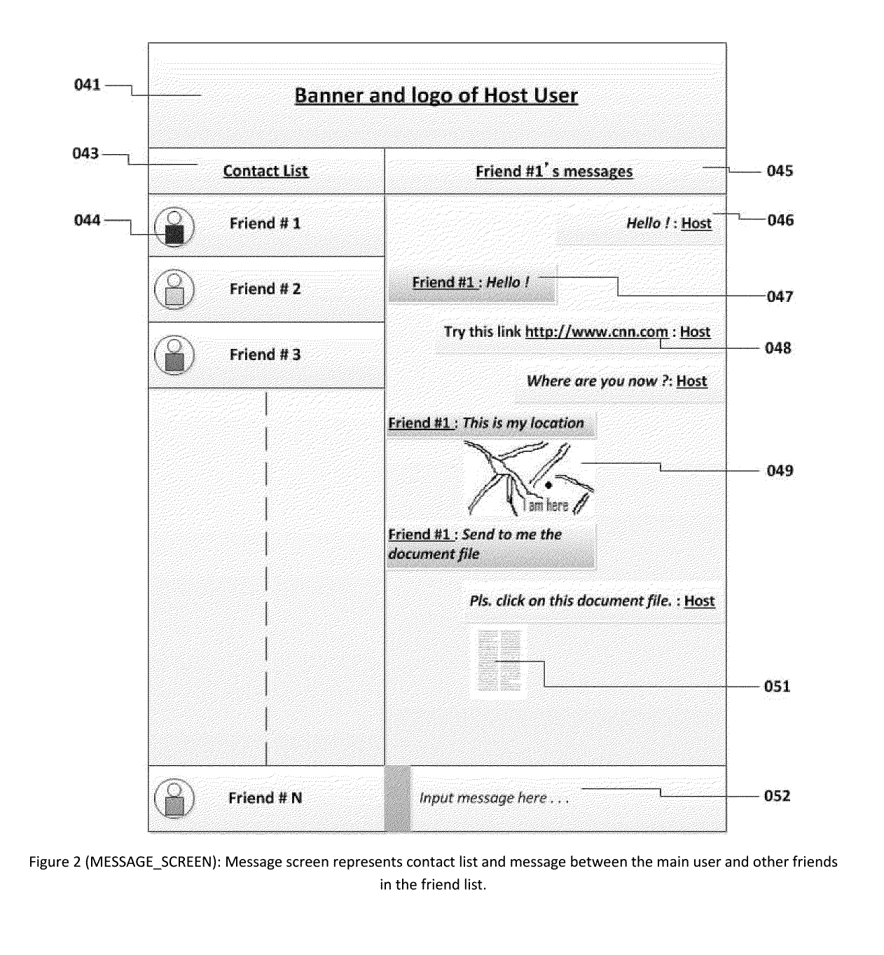

FIG. 2 (MESSAGE_SCREEN) shows the user interface of sending and receiving message. The information of user can be seen in the banner 041. The friend list is described in contact list 043 where the user can select and send message. All the messages between the user and his/her friend can be seen at window 046. The content of messages between two users can be a type of texts 046-047, URL of web 048, images 049, and document files 051. All messages can be inputted at 052 to broadcast to the other clients. If the receiver is in offline mode, all data will be kept on the MESSAGE and DATA server. When the receiver is in online mode, all data will be transferred from the system of servers to the receiver of the local device.

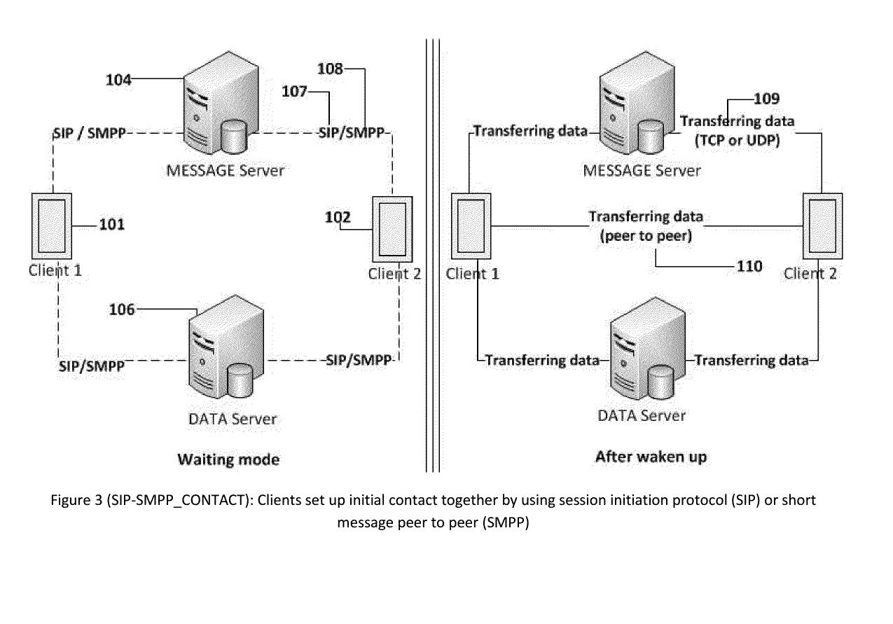

FIG. 3 (SIP-SMPP_CONTACT) describes the mechanism to set up the connection from one client's application 101 to the server systems of MESSAGE server 104 and DATA server 106, and to other client's application 102. In waiting (or offline) mode, client's application 101 does not always connect to the server. When there is a request for collaboration from a user, the client application will send a message through protocol of SIP 107 or SMPP 108 to the server system. After the server received SMPP/SIP's message from client devices, it will confirm authentication of user name and password; then, it will transfer client's request to another client by using SMPP/SIP's message also. At the same time, the server will generate one socket for client's application to handle the process of transferring data between clients' applications attended in the meeting by using TCP/IP or User Datagram Protocol (UDP) 109.

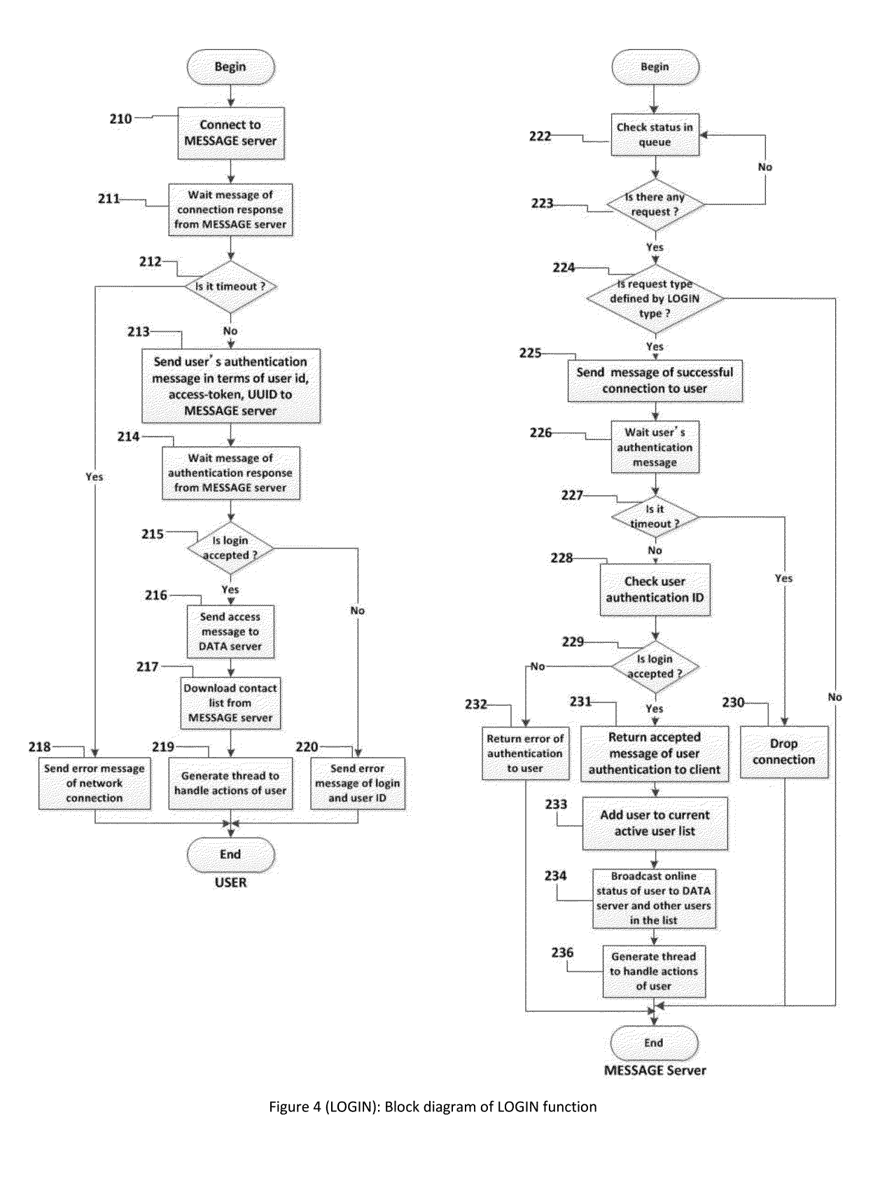

FIG. 4 (LOGIN) describes the login process of the system. The login function is the first module that the system will control to begin a transaction. The system will connect to the MESSAGE server 210 to check the network connection and user ID in a registration list. If the network connection and user ID are confirmed to be ready as steps of 213-214-215, the client application can contact the other user via a friend list 217 downloaded from the MESSAGE server. An online user can add, delete, or modify his/her friend list from the client application. The MESSAGE server will update the status 233 and broadcast that status 234 of the user to the other users in the user's friend list. At that time of connection, one thread to handle user's message is also generated by the MESSAGE server at 236.

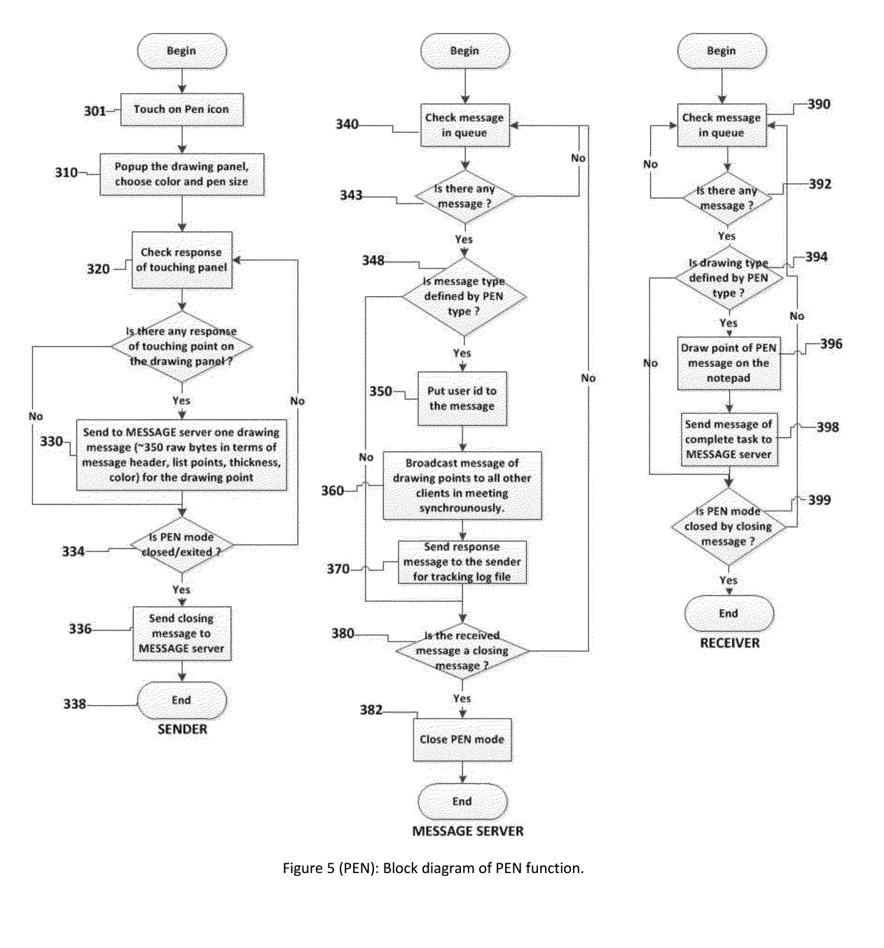

FIG. 5 (PEN) describes the block diagrams of the pen function. The user can activate this pen mode by touching the pen button 013. The pen style will be sent to the MESSAGE server from the initial step 310. When the end user starts to draw on the working pad, the list of drawing points in terms of x-coordinate, y-coordinate, and plot time will be sent to the MESSAGE server 330, and the MESSAGE server will broadcast those data to the other users through TCP/IP network 360. The other users at the meeting will receive messages broadcasted by the MESSAGE server. When the received message is a message of PEN type, the application in other users' computer will draw points by using PEN mode defined in the received message 394-396.

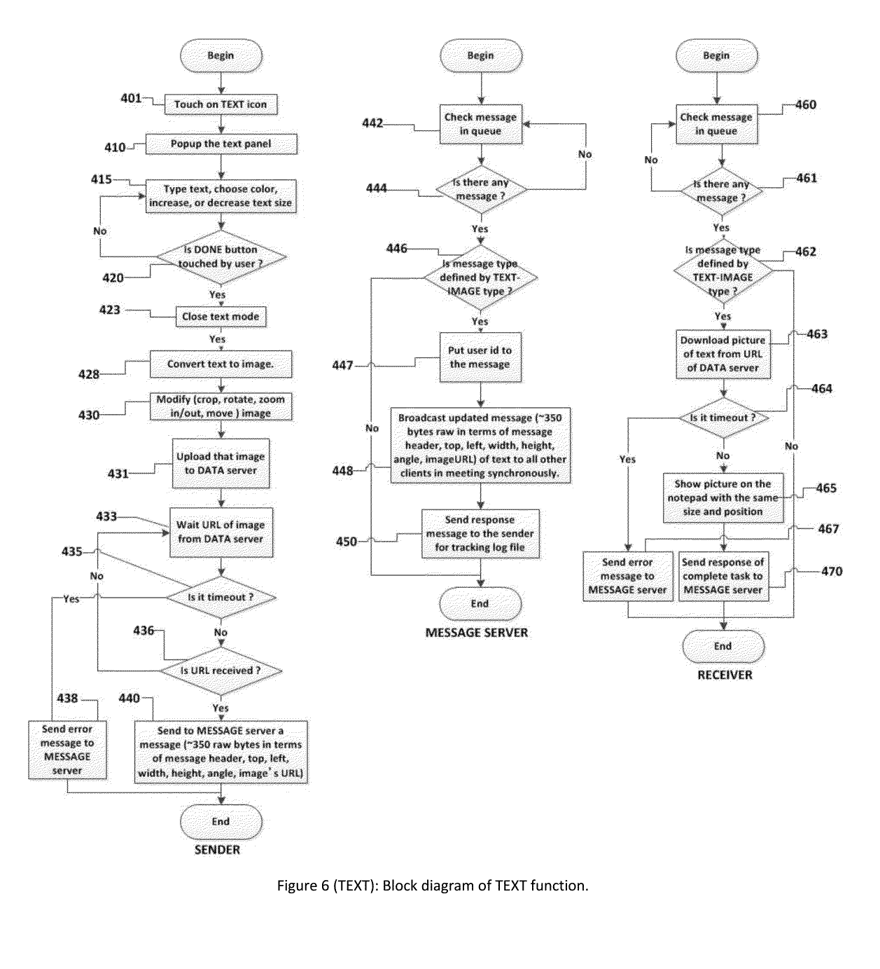

FIG. 6 (TEXT) describes a block diagram of the text function. The end user can activate this text mode 019 and type text on the drawing pad. When the end user finishes the text mode, the text will be converted into image 428 and that image will be sent to the DATA server 431. At the same time, the application of the sender will send messages of TEXT type to the MESSAGE server with its own parameters 440. The MESSAGE server will broadcast the received messages to the other user 448. The other user as receiver will receive messages of TEXT type from the MESSAGE server 462 and download images of text from the DATA server 463. The receiver's application will show images of text of the same size and position on its working board 465.

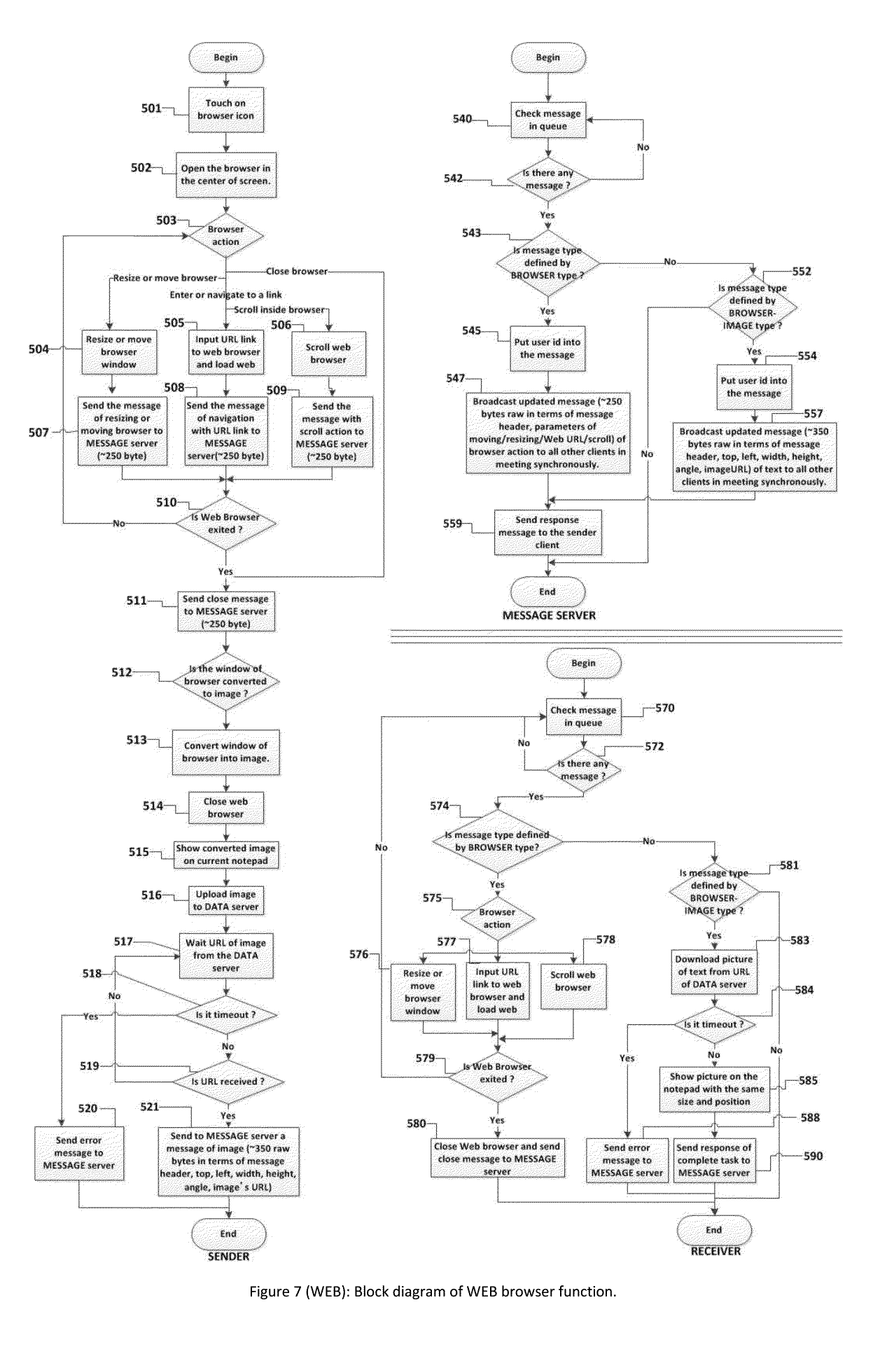

FIG. 7 (WEB) describes a block diagram of the Web browser function. The end user can activate this mode button 011 and launch the web browser window 021 inside the working pad screen. The client application will launch the web browser and send a message of WEB type to the MESSAGE server 508, where the URL of WEB will be encoded into the messages. For each action of web surfing or moving/scaling the window of web browser, one message is also generated and sent to the MESSAGE server 507-509. The MESSAGE server receives and broadcasts the sender's message to the other users at the meeting 547. The receivers' application will receive and launch the web browser 575-577. For each action, the receivers' application will generate the same action 576-578 at the window of its web browser by using the data broadcasted from the MESSAGE server. This process takes a very little time because the message size is about 250-350 bytes in terms of coordinates of mouse (or touch point), handle ID of actions (moving, resizing, scrolling), and the link of URL. When one user inputs URL to a web browser, the receiver's application will record and send that URL to the MESSAGE server through a message. The maximum size of a link message is 1 KB. When those users, both sender and receiver in this case, start to surf web, the web link is updated to the MESSAGE server and the MESSAGE server will broadcast the link to the other users' application at the meeting. The server will synchronize client's data such that it will keep the latest appearance of similar URL for all the web browsers of all users at the meeting. The latest link is defined by using the recorded time in a log file of the server.

When one of those interactive users closes or changes the web-browser mode to another mode, the screen of web-browser window will be transformed into an image with the permission of the user 512-513. After the web-browser window is converted to image mode, the converted image is uploaded into the DATA server 516 and one message is sent to the MESSAGE server 521. The MESSAGE server will broadcast a close message 547 and message of image 557 to the other users at the meeting. When receiving the close message, the receiver's applications will close the web browser 580. Moreover, the receiver's application will download image from DATA server and show that image at the same position on working board when it receives message of BROWSER-IMAGE type 583. After the image of the web-browser window is displayed, the users at the meeting can process and modify images by using pen, eraser, or clear functions.

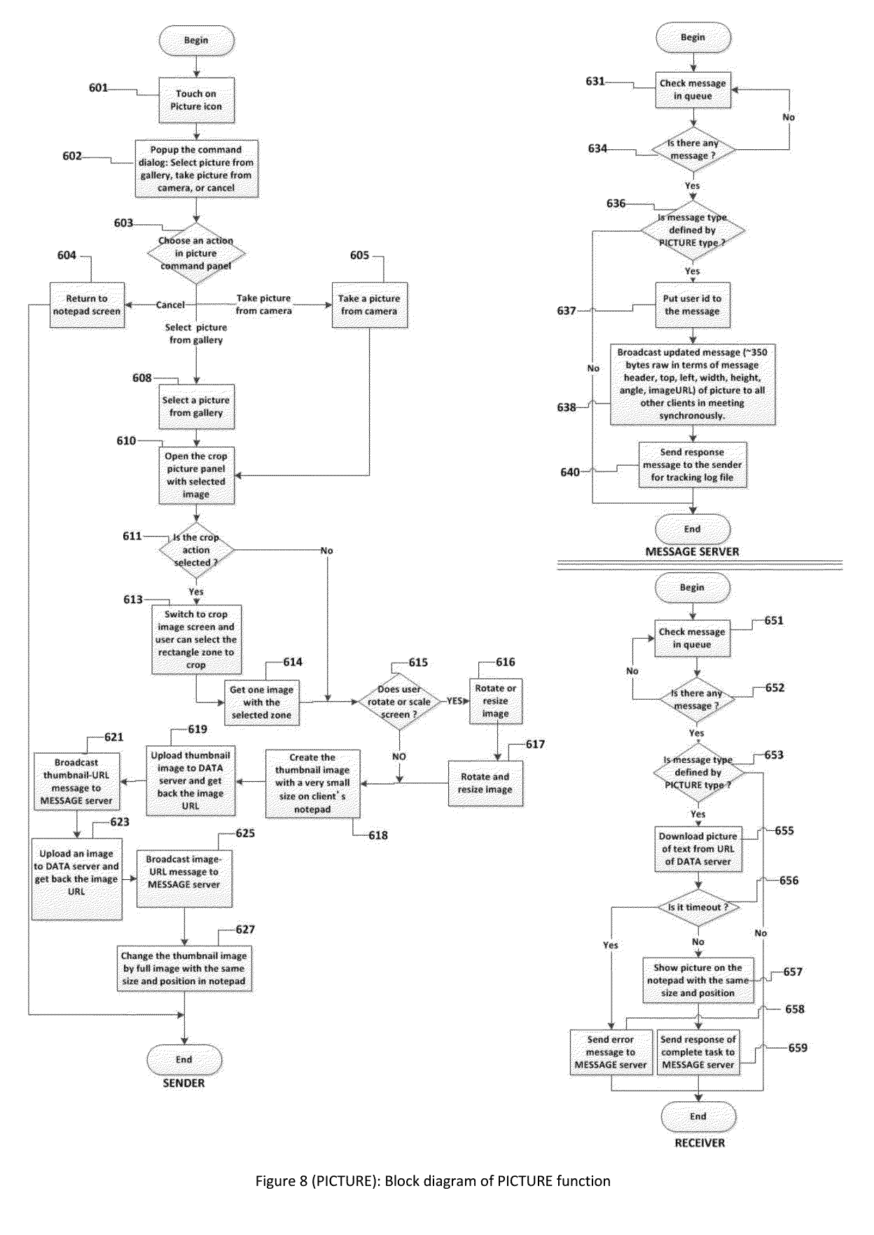

FIG. 8 (PICTURE) describes a block diagram of the picture function. The end user will activate this mode by touching the PHOTO button 017 and the application will give the end user two options 602. The first option is to take photo by using the device's camera 605. The second option is to select one image from a local folder 608. After taking a photo or uploading an image from the local folder, the result images will be modified on the working pad screen by cropping or rotation functions 613, 614 with 615, 616 and its thumbnails and real content (X-Y position, image data) are uploaded to the DATA server 618-619-623. The DATA server will generate an URL of the image and return that URL to the sender's application. The sender's application will send messages of the thumbnails and real images to the MESSAGE server 621-625. The MESSAGE server will broadcast URL to other clients by using message 638. The delivering of the messages is based on TCP/IP network. The receiver's application will download thumb-nail and real image after it receives messages from the DATA server 655. Note that the link of data on the DATA server is parsed from messages broadcasted by the MESSAGE server 638. After downloading data from the DATA server, the receiver's application will show thumbnails and real images on its working board 657.

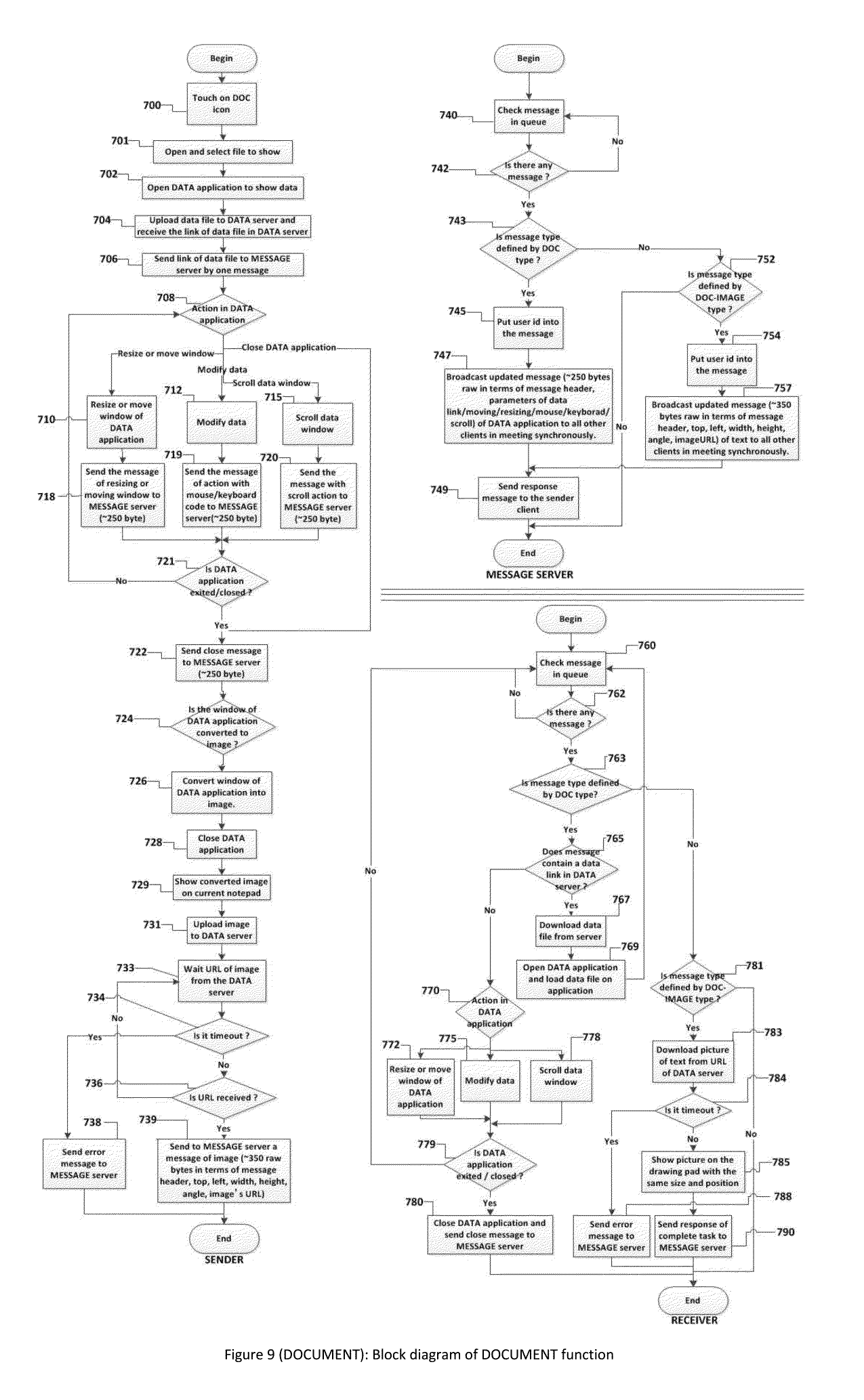

FIG. 9 (DOCUMENT) describes a block diagram of the document function. The user activates the document function by touching DOC button 020. User can open documents on the local drive or cloud-based storage such as Dropbox or Google drive 702. The data file is uploaded from the storage device into the DATA server 704-706 by a client's application. At the same time, other users' applications will download the data from the MESSAGE server and DATA server 765-767 and show downloaded data file in its correspondent application which is present in the drawing pad window. When one user modifies the data, a message of the user's action (changing window's size, modify data, drawing on data's window, scrolling data's window) will be sent to the MESSAGE server 722 and it is broadcasted to all users' application at the meeting 747. Thanks to messages broadcasted by the MESSAGE server, all other users' applications will generate the same action and show results in their drawing pad immediately 770, 772, 775, and 778. When one user closes the emulated application, the window of emulated application can be saved into an image 724-726 and it is broadcasted to all other's users via the server system 781-783.

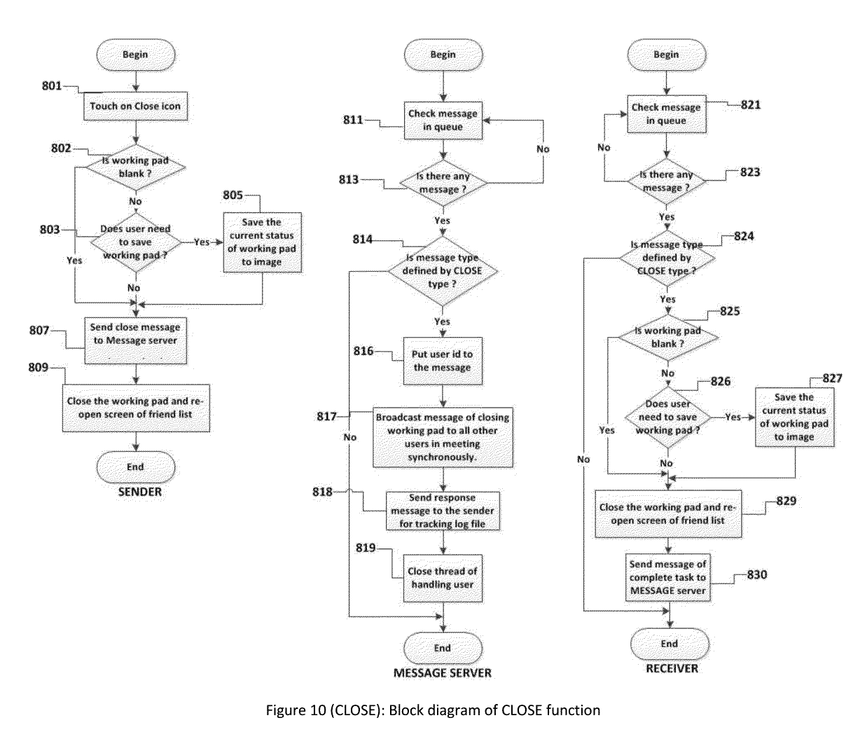

FIG. 10 (CLOSE) describes block diagrams of the close function. The user activates close function by touching close button 012. The end-user application will ask whether the user saves the current status of the working pad into an image or not before it closes the working pad 803 and the user's application will send a close message to the MESSAGE server 807. The server will broadcast the close function to the other users 817. When another terminal receives the message from the server, it will call close function to do task immediately 824, 825, 826, 827, 829, and the DATA server will delete all temporary users' data on the server.

What is claimed is:

1. In general, in a one aspect, this invention is a collaborative and interactive environment for sharing photos, documents, screens, and drawing pictures between multiple users by using working pad, web browser, and emulated applications to read and share documents through TCP/IP network. The users can use co-drawing pad, co-browsing and co-sharing Web page/document files.

2. The system of the first claim wherein comprising the server application. There are two kinds of server applications. The first kind is data server, where data is stored, downloaded, uploaded, and shared to all client applications in a private group. The second kind of server is message server, which receives, transmits, and broadcasts all the messages sent by one client application to the others.

3. The system of the first claim wherein comprising the client application. There are twelve functions in the client application such as connection, pen, text, picture, web browser, redo/undo, eraser, clear, document, message, and close.

4. The system of the first claim wherein comprising the web browser emulated into the drawing pad. The sharing of web data and co-browsing of web are processed and displayed in real time. It means that one end user can draw on their pads in a client application or surf the Web emulated on the drawing pad and at the same time the other end-users can see those changes on their drawing pad. The client application will send/receive messages to/from the Message server and the Message server will broadcast its actions to the other clients. After receiving the action from the other clients through the message of the Message server, the client application will synchronize its conditions. The system of sending/receiving text message is based on TCP/IP network.

5. The system of the first claim wherein comprising the ability to transfer data (raw text, images or documents) through client/server mode by using text messages. Text messages will include the sent/received time, the name of the sender, and the link of storing data such as text, images, or document files located in the data server or in a cloud-based system.

6. The system of the first claim wherein comprising the ability to convert one emulated application displayed in the drawing pad into the background image. After that the end users can modify the background image by drawing some free-shape points, adding highlights, or typing some text in the background image. At the same time, all the other end users at the meeting can see those changes in their drawing pads.

7. In general, in a one aspect, the term of the second claim is the full-time and low-energy connection between client devices and the server.

8. The system of the second claim wherein comprising the implementation of the session initial protocol (SIP) to sustain connection between client applications and the server. This connection helps one client application to wake up the other client application installed in a remote device such as a computer, mobile phone, tablet, or home appliance, etc, through a SIP message.

9. The system of the second claim wherein comprising the implementation of the short-message peer-to-peer protocol (SMPP) to sustain connection between client applications and the server. This connection helps one client application to activate the other client application installed in a remote device such as a computer, mobile phone, tablet, or home appliance through a SMPP message.

10. In general, in a one aspect, the term of the third claim is to use a message to describe an address link to a Web page, a URL link to a picture, or a URL link to document files on the server, and the server/host client can broadcast the message to the other clients through the system of servers. The application of other clients can download pictures, web pages, or document files by using the URL link in the message. After being downloaded, the data files are automatically displayed on the working pad.
